(19) United States
(12) Patent Application Publication
(10) Pub. No.: US 2004/0201574 A1
(43) Pub. Date: Oct. 14, 2004

(54) Mouse having attached base

(76) Inventor: Jose Wei, Hsin Tien City (TW)

Correspondence Address: DENNISON, SCHULTZ & DOUGHERTY, Suite 612, 1745 Jefferson Davis Highway, Arlington, VA, 22202, US

(21) Appl. No.: 10/460,156

(22) Filed: Jun. 13, 2003

(30) Foreign Application Priority Data
Apr. 11, 2003 (TW) 092205743

(51) Int. Cl. G09G 5/08

(52) U.S. Cl. 345/163

(57) ABSTRACT

A mouse having an attached base includes a mouse body provided with a cord having a predetermined length extended from a rear end thereof, wherein an outer end of the cord is connected with a terminal plug; and a base consisted of an upper housing and a lower housing, and upper and lower guiding orifices, wherein the cord is penetrated into the base via the upper guiding orifice and extended out of the base via the lower guiding orifice, and an inner surface of the mouse body is superposed and fastened to a surface of the base. Using the aforesaid structure, the mouse may be selectively separated or connected to the base.

### BACKGROUND OF THE INVENTION

(a) Field of the Invention

The invention relates to a mouse having an attached base, and more particularly, to a mouse having an attached base connected with a cord extended from a rear end thereof, thereby superposing a mouse body thereof with the base.

(b) Description of the Prior Art

Referring to a prototypic cord storage device for mouse disclosed in the Taiwan Patent Publication No. 446903, Mouse Capable of Storing Signal Cord, the prior invention utilizes two disk-like guiding members manually operated and winded for releasing or collecting a signal cord from or into an accommodating room at an interior of a mouse. However, the signal cord is likely to get tangled and thus stored in disorder when being collected into the accommodating room. Also, the invention lacks designs of elastic elements capable of automatically collecting the cord, and hence winding of the guiding members and are manually operated; the invention as a whole is rather inconvenient. In addition, the cord storage device is disposed on the mouse, and therefore a length of cord that can be stored is rather limited.

Referring to another invention disclosed in the Taiwan Patent Publication No. 519264, Mouse Having Cord Storage Chamber, wherein upper and lower housings and are connected using a center axis that further forms a cord storage chamber at a space at an exterior thereof, and a signal cord is winded and stored around the center axis. When the signal cord is extracted using a human hand, the mouse body is rotated as well; and when the cord is collected into the cord storage chamber using a human hand, it is also necessary to manually rotate the mouse body in a reverse direction. The collecting and releasing of such mouse are entire completed using manual operations, and are thus quite inappropriate. Furthermore, the cord storage device is disposed on the mouse body, and a length of cord that can be stored or released is yet quite limited.

Referring to another invention disclosed in the Taiwan Patent Publication No. 444174, Mouse Having Cable Winding Device, this prior invention utilizes an elastic element for driving a single cord storage wheel flexibly connected on an axis thereof such that when a signal cord is released out of or collected into the cord storage wheel, in order to have the signal cord conduct to internal circuits of the mouse, a conductive body is provided at the cord storage wheel, so that the conductive body is rubbed against an immovable cover piece having a printed conductive layer at an internal surface thereof when the conductive body is rotated simultaneously with the cord storage wheel. In the long term, the conductive body is abraded and deformed or the conductive layer at the internal surface of the cover piece becomes worn for that the conductive body is constantly rubbed against the conductive layer at the inner surface of the cover piece, and thus finally leading to poor contact and conduction. More particularly, the cord storage device is disposed on the mouse body, and thus a length of cord that can be stored or released is limited as a result.

Referring to the inventor's prior invention disclosed in the U.S. Pat. No. 6,434,249B1, Earphone Wire Winding Box with Coaxial and Dual Wheels, the invention overcomes the problem of poor contact between conductive terminal of circuits and circuit structure of an electric appliance as described in the aforesaid invention. Two turning wheels, one large and one small, are provided in the inventor's prior invention, wherein a signal wire is stored on wheel breadths of the large and small turning wheels and, through which one conductive terminal of the signal wire is kept fixed, so that sliding movements are not required for electrically connecting a conductive element thereof with circuit elements at an interior of the at an interior of the electric appliance.

The inventor's prior invention is indeed quite useful; however, fields of applications of the invention are restricted to certain devices only.

### SUMMARY OF THE INVENTION

Therefore, the primary object of the invention is to provide a mouse having an attached base, wherein a mouse body thereof is superposed and connected with a base having a storage chamber at an interior thereof, thereby enabling the mouse to be selectively separated or fastened with the base.

The other object of the invention is to provide a mouse having an attached base, wherein the storage chamber at the interior of the base is provided with a cord winding device, thereby storing or releasing a cord of a longer length connected with the mouse.

### BRIEF DESCRIPTION OF THE DRAWINGS

FIG. 1 shows an exploded elevational view illustrating the mouse body and the base being connected according to the invention.

FIG. 2 shows a sectional view of the base according to the invention.

FIG. 3 shows another exploded elevational view according to the invention.

FIG. 4 shows an enlarged elevational view the arched edges of the base according to the invention.

FIG. 5 shows a sectional view illustrating the A and B cord storage wheels having same diameters at the interior of the base according to the invention.

FIG. 6 shows a side schematic view illustrating motions of the large and small turning wheels making coaxial rotations according to the invention.

### DETAILED DESCRIPTION OF THE PREFERRED EMBODIMENTS

To accomplish the aforesaid objects and to better understand the characteristics and functions of the invention, detailed descriptions shall be given with the accompanying drawings hereunder.

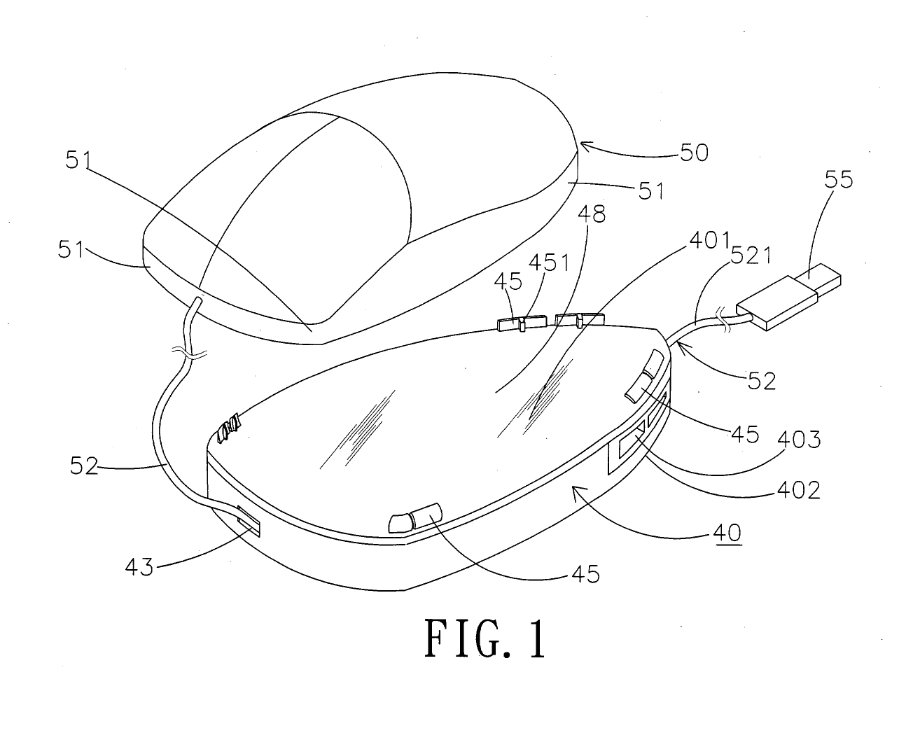

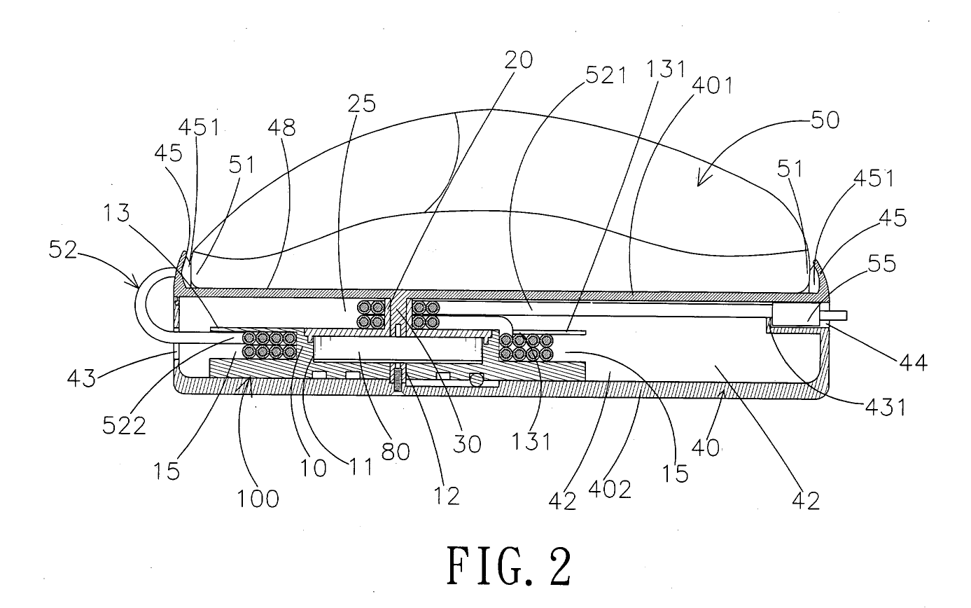

Referring to FIGS. 1 and 2, the invention comprises the characteristics of:

a mouse body 50 provided with a cord 52 having a predetermined length extended from a rear end thereof, wherein an outer end of the cord 52 is connected with a terminal plug 55; and

a base 40 consisted of an upper housing 401 and a lower housing 402, and upper and lower guiding orifices 43 and 44, wherein the cord 52 is penetrated into the base 40 via the upper guiding orifice 43 and extended out of the base 40 via the lower guiding orifice 44, and an inner surface of the mouse body 50 is superposed and fastened to a surface 48 of the base 40 as shown in FIG. 2.

According to the aforesaid primary characteristic, wherein lateral edges of the base 40 are provided with arched edges 45, such that an outer periphery 51 of the mouse body is butted against and fastened to inner walls of the arched edges 45, thereby mounting and positioning the mouse body 50 onto the surface 48 of the base 40.

According to the aforesaid primary characteristics, wherein an interior of the base 40 is provided with a storage chamber 42 having a cord winding device 100 for accommodating the cord 52.

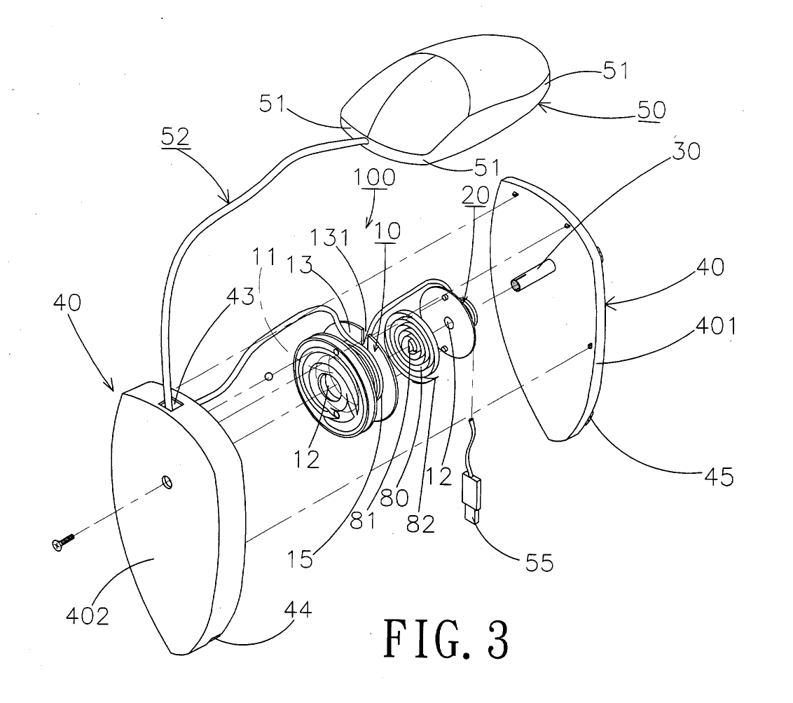

According to the aforesaid secondary characteristics and referring to FIG. 3, the cord winding device 100 comprises:

an immovable axis 30 fixed in the storage chamber 42;

at least two A and B cord storage wheels 10 and 20 combined into one body and having a same center opening 12, wherein the center opening 12 is flexibly connected around the immovable axis 30;

A and B cord storage grooves 15 and 25, wherein the cord 52 is winded and stored in the A and B cord storage grooves 15 and 25; and

a spring 80 placed in a side recess 11 provided at the A cord storage wheel 10, wherein an inner end 81 of the spring 80 is fixed to the immovable axis 30 whereas the other end 82 thereof is fixed to a side wall of the side recess 11.

According to the aforesaid secondary characteristics, between the A and B cord storage wheels 10 and 20 is a ring piece 13 provided with a wedging notch 131. The cord 52 is extended from the A cord storage groove 15 into the B cord storage groove 25, and forms a stop portion 431 of the cord 52 at the wedging notch 131.

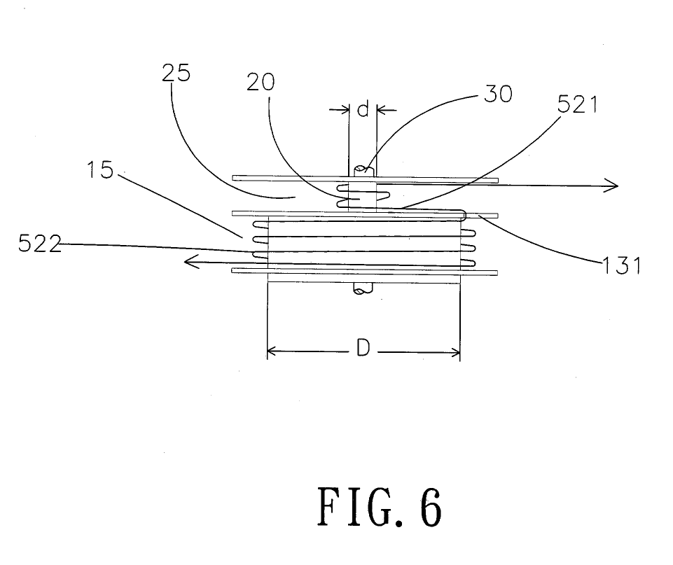

According to the aforesaid secondary characteristics, diameters D and d of the A and B cord storage wheels 10 and 20 may be different or the same as shown in FIG. 6.

### EXAMPLES

According to accomplishment of the aforesaid primary and secondary characteristics, the invention has the excellences when being implemented as in the following examples.

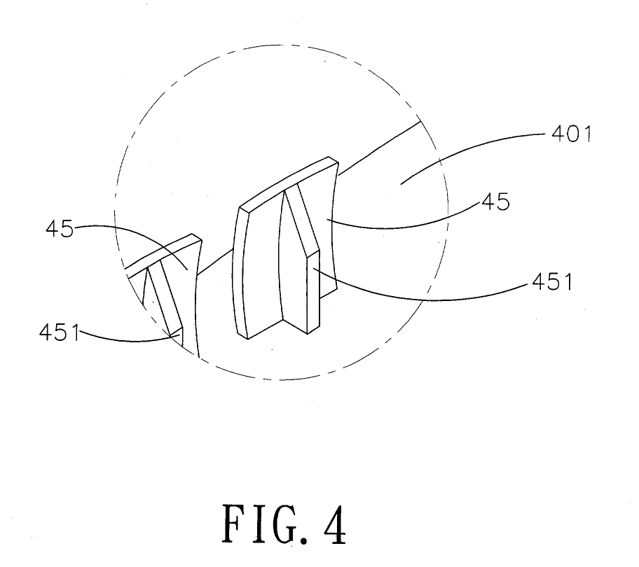

1. Referring to FIGS. 1, 2 and 4, inner lateral sides of the arched edges 45 are provided with slanting flanges 451 for the mouse body 50 to fasten to the surface 48 in a downward direction. A periphery 51 of the mouse body 50 is butted against the flanges 451 such that the arched edges 45 are deformed outwardly with elasticity, thereby effectively mounting and positioning the mouse body 50 onto the surface 48 and combining the mouse body 50 with the base 40 into one body for easy storage and carrying. To use the structure, only the mouse body 50 needs to be pulled out from the base 40 in an upward direction, then forces imposed by the flanges 451 are dismissed and the arched edges 45 are elastically repositioned. A user may further assemble or dismantle the mouse body 50 with or from the base 40.

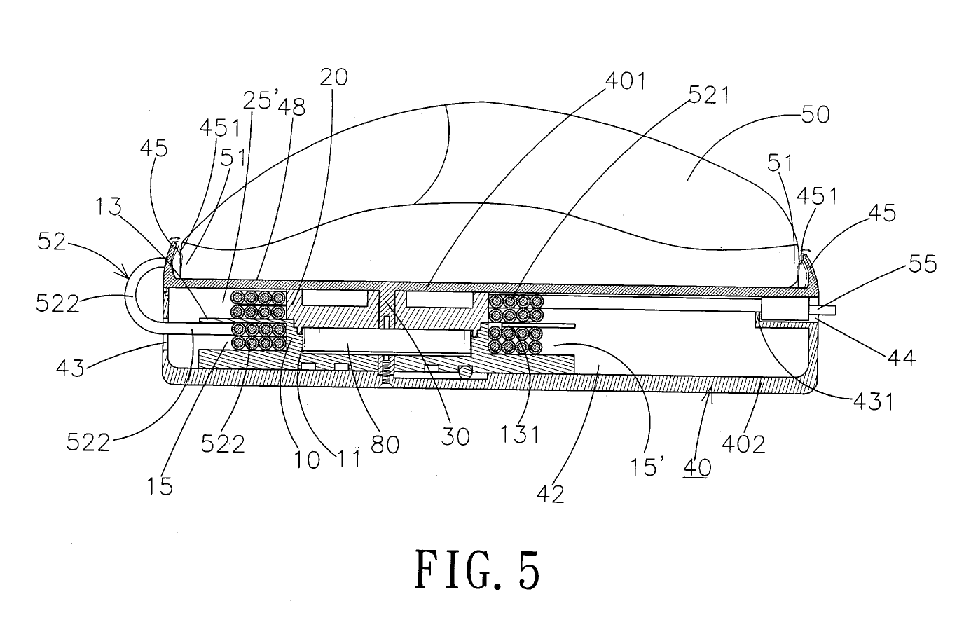

2. Referring to FIGS. 2, 3 and 6, according to the cord winding device 100 disposed in the storage chamber 42 at the interior or the base 40, the A and B cord storage wheels 10 and 20 therein are both flexibly connected to the same immovable axis 30. Hence, when the A cord storage wheel 10 rotates one revolution, the B cord storage wheel 20 rotates one revolution as well. For one revolution made by the A cord storage wheel 10, a length of an outer cord 522 being released from (or winded into) the A cord storage groove 15 is π×D, where D is the diameter of the A cord storage wheel 10. Similarly, for one revolution made by the B cord storage wheel 20, a length of an inner cord 521 being released from (or winded into) the B cord storage groove 25 is π×d, where d is the diameter of the B cord storage wheel 20. Therefore, when A and B cord storage wheels 10 and 20 rotate coaxially, the ratio of lengths of the cords released (or winded) equals to the ratio of diameters of the A and B cord storage wheels 10 and 20; that is, D: d. In a preferred embodiment of the invention, the ratio of diameters of the A and B cord storage wheels 10 and 20 is 10:1. When the outer cord 522 is extracted when the mouse body 50 is pulled out by the user, the inner cord 521 having the plug 55 is also released along. Suppose the length of the outer cord 522 being released for the usage of the mouse body 50 is 50 cm, the inner cord 521 released from the B cord storage groove 25 is 5 cm measuring from the lower guiding orifice 44. The plug 55 connected to the outer end of the inner cord 521 may be then plugged to an electric appliance. In addition, when the mouse body 50 is pulled out and displaced, excessive displacement between the plug 55 and the base 40 is not incurred. During cord winding, the spring 80 imposes a contraction effect on the A and B cord storage wheels 10 and 20, and thus the inner and outer cords 521 and 522 are winded back into the A and B cord storage grooves 15 and 25. Wherein, a rear end of the plug 55 is stopped at the stop portion 431 that provides a positioning effect when the plug 55 is being restored back into the base 40 as shown in FIGS. 3 and 5.

3. Referring to FIG. 5, the A and B cord storage wheels 10 and 20 may also be designed as having same diameters (1:1) for adapting to various operating environments or special requirements, and hence the lengths of the inner and outer cords 521 and 522 are equal to each other when being released. Referring to FIG. 1, at a side of the base 40 is provided with a socket 403 for inserting a plug based upon requirements.

It is of course to be understood that the embodiments described herein are merely illustrative of the principles of the invention and that a wide variety of modifications thereto may be effected by persons skilled in the art without departing from the spirit and scope of the invention as set forth in the following claims.

What is claimed is:

1. A mouse having an attached base comprising:
a mouse body provided with a cord having a predetermined length extended from a rear end thereof, wherein an outer end of the cord is connected with a terminal plug; and
a base consisted of an upper housing and a lower housing, and upper and lower guiding orifices, wherein the cord is penetrated into the base via the upper guiding orifice and extended out of the base via the lower guiding orifice, and an inner surface of the mouse body is superposed and fastened to a surface of the base.

2. The mouse having an attached base in accordance claim 1, wherein lateral edges of the base are provided with arched edges, such that an outer periphery of the mouse body is butted against and fastened to inner walls of the arched edges, thereby mounting and positioning the mouse body onto the surface of the base.

3. The mouse having an attached base in accordance claim 1, wherein an interior of the base is provided with a storage chamber having a cord winding device for accommodating the cord.

4. The mouse having an attached base in accordance claim 1, wherein the cord storage device further comprising:
an immovable axis fixed in the storage chamber;
at least two A and B cord storage wheels combined into one body and having a same center opening, wherein the center opening is flexibly connected around the immovable axis;
A and B cord storage grooves, wherein the cord is winded and stored in the A and B cord storage grooves; and
a spring placed in a side recess provided at the A cord storage wheel, wherein an inner end of the spring is fixed to the immovable axis whereas the other end thereof is fixed to a side wall of the side recess.

5. The mouse having an attached base in accordance claim 1, wherein between the A and B cord storage wheels is a ring piece provided with a wedging notch; and the cord is extended from the A cord storage groove into the B cord storage groove, and forms a stop portion of the cord at the wedging notch.

6. The mouse having an attached base in accordance claim 1, wherein the A and B cord storage wheels have different or same diameters.
